(19) United States
(12) Patent Application Publication
(10) Pub. No.: US 2026/0117013 A1
(43) Pub. Date: Apr. 30, 2026

(54) Aqueous Curable Multi-Component System

(71) Applicant: omniTECHNIK Mikroverkapselungs GmbH, München (DE)

(72) Inventors: Sebastian Thau, München (DE); Thomas Fey, München (DE); Karin Lüdtke, München (DE); Manuela Stirner, München (DE); Agron Berisha, München (DE)

(73) Assignee: omniTECHNIK Mikroverkapselungs GmbH, München (DE)

(21) Appl. No.: 19/151,234

(22) PCT Filed: Jan. 25, 2024
(86) PCT No.: PCT/EP2024/051788

§ 371 Date: Jul. 25, 2025

(30) Foreign Application Priority Data
Jan. 26, 2023 (DE) 10 2023 101 961.9

(51) Int. Cl. C08F 265/06; C08F 2/44; C08F 4/34

(52) U.S. Cl. CPC C08F 265/06; C08F 2/44; C08F 4/34

(57) ABSTRACT

The invention relates to a multi-component system comprising a first component, a second component and optionally one or more further components,
wherein the first component comprises capsules containing polymerizable (meth)acrylate functional binder and water, and
wherein the second component comprises peroxodisulfate initiator, encapsulated dibenzoyl peroxide initiator and water.

The present invention relates to a multi-component system, in particular a two-component aqueous system containing capsules, which enables mixing of the components by breaking open the capsules and initiates the process of self-curing. The multi-component system is particularly suitable as a coating which can serve as a sealant and/or as an adhesive for fixing fasteners such as screws.

Adhesive or curable coatings for screws are known in the state of the art. Such coatings are used, for example, in automotive engineering or in structural and civil engineering to prevent the unintentional loosening or coming loose of a screw connection due to corrosion or vibration. Coatings are known that have to be applied in liquid form immediately before the screw is used. Pre-coated screws, on the other hand, have the advantage that the coating can be reliably applied in a standardized manner. Faulty screw connections can be avoided in this way. In such applications of pre-coated screws for securing and sealing, the polymerization of polymerizable components of the coating is usually initiated when two plates are joined by means of a screw.

In principle, adhesive bonding can be achieved using anaerobic adhesives. Anaerobic adhesives, also known as one-component adhesives or “liquid plastics”, remain in a liquid state and do not polymerize as long as the presence of oxygen prevents radical polymerization. If screws coated with such a liquid adhesive are screwed, polymerization is initiated at contact points in the presence of metal ions from the screw or thread or the material to be screwed and in the absence of oxygen, and the screw is secured and sealed. A fundamental problem with such adhesives is the liquid nature of the coating. Suggestions on how the grip of single-component adhesives can be improved as a pre-coating for screw locking include WO 2017/068196 A1, in which polymerizable material with a melting point of at least 30° C. is used.

Two-component adhesives differ from anaerobic adhesives in that no metal ions need to be present for polymerization and they also polymerize in the presence of oxygen. The initiator or hardener are therefore separate from the polymerizable components. An adhesive bond can then be achieved, for example, by destroying microcapsules containing an adhesive to be polymerized during screwing and the released adhesive comes into contact with hardener contained in the coating, which initiates polymerization. DE 10 2011 119 140 A1 describes such a coating for a threaded part, such as a screw, which contains microcapsules with a polymerizable adhesive and additional non-reactive components to achieve a clamping effect. Adhesive coatings based on, for example, encapsulated epoxy components with amine hardener, based on polyester systems or alternatively based on (meth)acrylate and radical initiators are known in principle as microencapsulated multi-component systems.

Microcapsules are described in WO 95/33554 A1, among others.

Various methods of applying the coating to the fastener, for example the screw, are known in the art. One method, for example, is to melt the coating composition or parts of the coating composition and apply it as a melt. Optionally, components containing (micro-) capsules are then applied in a further step in a liquid organic carrier medium, whereby this carrier medium is described in DE 10 2011 119 140 A1, for example, as a UV-curable carrier medium that covers the coating with a lacquer. Such a lacquer can also be used to protect a liquid to viscous polymerizable adhesive composition from leaking and to provide to it grip. However, lacquer coatings are generally susceptible to mechanical damage, which can hardly be avoided when using and storing the screws. Coatings that do not require their own protective layer, such as a lacquer, are therefore desirable. To reduce health hazards caused by volatile organic compounds (VOCs), the industry is also making efforts to apply curable adhesive coatings in aqueous form and thus avoid VOCs.

An aqueous system is described in WO 2011/047738 as an aqueous composition of polymerizable acrylate components and encapsulated radical initiator as initiator. EP 3 165 584 A1 describes a further aqueous acrylate-based system with preferably encapsulated radical initiator.

However, multi-component systems are still required that offer advantages over the known systems in terms of process parameters, process reliability and pot life, as well as in terms of the properties and strengths, breakaway torques and sealing properties achieved. In addition, the multi-component system should result in a coating that is easy to apply to fasteners such as screws or threaded screws, which has grip, is dry, mechanically durable and chemically stable in normal use.

The present invention solves at least one of these objects and optionally further objects by means of a multi-component system comprising a first component, a second component and optionally one or more further components,
wherein the first component comprises capsules containing polymerizable (meth)acrylate functional binder and water, and
wherein the second component comprises peroxodisulfate initiator, encapsulated dibenzoyl peroxide initiator and water.

In a second aspect of the invention, at least one of these objects is solved by a composition prepared by mixing the components of the multicomponent system of the invention.

In a third aspect of the invention, at least one of these objects is solved by using the multicomponent system or composition of the invention to improve the pot life, the process reliability and/or to coat a fastener, in particular a screw, in order to increase the breakaway torque of the fastener and/or to improve the tightness of the joint of the fastener.

In a fourth aspect of the invention, at least one of these tasks is solved by a fastening means, in particular a screw, characterized in that it is coated with the composition according to the invention.

As described, the multicomponent system of the invention comprises a first component, a second component and optionally one or more further components,
wherein the first component comprises capsules containing polymerizable (meth)acrylate functional binder and water, and
wherein the second component comprises peroxodisulfate initiator, encapsulated dibenzoyl peroxide initiator and water. This is to be understood as meaning that the multicomponent system of the invention preferably comprises the first component and the second component and may optionally comprise an additional or further components. These components may be present separately or, for example for use, in a mixed form.

The presence of the two different initiators in the second component, of which the dibenzoyl peroxide initiator is encapsulated, results in a surprisingly increased adhesive effect, which is reflected in surprisingly increased breakaway torques when applied to threaded screws.

Preferably, the multi-component system (in the case of the preferred two components: the two-component system) of the invention serves as a sealant and/or adhesive for coating fastening means, in particular for coating screws, for example threaded screws or also internal threads, as used in a wide variety of areas. These include industrial applications, for example in the automotive industry and in the electronics industry. In principle, the invention is advantageous wherever reliable screw locking against loosening by vibration is required.

Preferably, the first component comprises capsules, in particular microcapsules, wherein the capsules, in particular microcapsules, have a shell and an inner phase. The inner phase preferably contains polymerizable (meth)acrylate-functional binder and optionally crosslinker, in particular (meth)acrylate-functional crosslinker, and preferably one or more accelerators.

Suitable polymerizable (meth)acrylate-functional binders are for example: (meth)acrylated epoxy resin, (meth)acrylated polyurethane, (meth)acrylate-functional polyesters and especially (meth)acrylate-functional binders based on bisphenol-A or bisphenol (e.g. bisphenol-A dimethacrylate), (meth)acrylate-functional binder based on novolak, (meth)acrylate-functional binder based on bisphenol-A epoxy or bisphenol epoxy (e.g. bisphenol-A diglycidyl methacrylate); (meth)acrylate-functional binder based on epoxy novolaks, (meth)acrylate-functional binder based on ethoxylated novolaks and mixtures thereof.

According to the invention, the crosslinker can preferably be selected from (meth)acrylic-functional monomers, for example from monomers with two, preferably three or also several (meth)acrylic functions. These include, for example, divinylbenzene (DVB); 1,3-butanediol dimethacrylate (BGDMA); tripropylene glycol diacrylate (TRPGDA); trimethylolpropane trimethacrylate (TMPTMA), isocyanurate tri(meth)acrylate, PETA pentaerythritol tetra(meth)acrylate, DiPETA; dipentaerythritol pentaacrylate, dipentaerythritol tetra(meth)acrylate, dipentaerythritol tetra(meth)acrylate etc and/or trimethylolpropane triacrylate (TMPTA). Trimethylolpropane trimethacrylate is particularly preferred according to the invention.

According to the invention, the first component may advantageously additionally contain one or more non-encapsulated polymerizable component(s), preferably non-encapsulated reactive binder and/or reactive diluent, optionally additionally fillers and/or thickeners.

Non-encapsulated reactive binders may be selected from the same reactive binders as the encapsulated polymerizable (meth)acrylate functional binder(s) of the first component. Preferably, they can each be independently the same or a different polymerizable binder. In addition, they may also be selected, for example, from double bond functional polymerizable polyurethanes and/or double bond functional polyesters or polycarbonates such as those commercially available from resin manufacturers such as Allnex, Alberdingk Boley, DSM Neoresins and many other resin manufacturers known to the skilled person. Particularly preferred non-encapsulated reactive binders according to the invention are double bond functional polymerizable polyurethanes and/or polyesters Lux 481; Ucecoat 7738, Ucecoat 7999, Ucecoat 7733 and similar commercial resins such as those used for radiation-curable systems such as wood coatings, adhesives, etc.

Suitable reactive diluents are, for example, alkoxylated acryloyl compounds such as (ethoxylated)₂₋₄₀ 1,6-hexanediol di(meth)acrylate, (propoxylated)₂₋₄₀ 1,6-hexanediol di(meth)acrylate, (ethoxylated)₂₋₄₀ 1,4-butanediol di(meth)acrylate, (propoxylated)₂₋₄₀ 1,4-butanediol di(meth)acrylate, (ethoxylated)₂₋₄₀ 1,3-butanediol di(meth)acrylate, (propoxylated)₂₋₄₀ 1,3-butanediol di(meth)acrylate, (ethoxylated)₂₋₄₀ ethylene glycol di(meth)acrylate, (propoxylated)₂₋₄₀ ethylene glycol di(meth)acrylate, (ethoxylated)₂₋₄₀ Propylene glycol di(meth)acrylate, (propoxylated)₂₋₄₀ propylene glycol di(meth)acrylate, (ethoxylated)₂₋₄₀ 1,4-cyclohexanedimethanol di(meth)acrylate, (propoxylated)₂₋₄₀ 1,4-cyclohexanedimethanol di(meth)acrylate, (ethoxylated)₂₋₄₀ Bisphenol-A di(meth)acrylate, (propoxylated)₂₋₄₀ Bisphenol-A di(meth)acrylate, (ethoxylated)₃₋₆₀ glycerol tri(meth)acrylate, (propoxylated)₃₋₆₀ glycerol tri(meth)acrylate, (ethoxylated)₃₋₆₀ Trimethylolpropane tri(meth)acrylate, (propoxylated)₃₋₆₀ trimethylolpropane tri(meth)acrylate, (ethoxylated)₃₋₆₀ isocyanurate tri(meth)acrylate, (ethoxylated)₃₋₆₀ isocyanurate tri(meth)acrylate, (ethoxylated)₄₋₈₀ Pentaerythritol tetra(meth)acrylate, (propoxylated)₄₋₈₀ pentaerythritol tetra(meth)acrylate, (ethoxylated)₆₋₁₂₀ dipentaerythritol tetra(meth)acrylate, (propoxylated)₆₋₁₂₀ dipentaerythritol tetra(meth)acrylate. Particularly preferred are polyethylene glycol dimethacrylate, in particular (polyethylene)₂-xx glycol dimethacrylate, and/or methacryloylethoxysuccinate.

Advantageously, according to the invention, the first component can comprise at least two different types of capsules which differ at least in the material of their respective shells, wherein preferably one type of capsule has a melamine-formaldehyde shell and a second type of capsule has a gelatine shell and wherein preferably both types of capsules are microcapsules. Surprisingly, it has been shown that the use of different materials for two different capsule types results in extended pot lives and increased process reliability, as well as improved breakaway torques when applied as a coating for threaded screws.

The capsule type with the melamine-formaldehyde shell typically has a size of (d50 in [μm]) 1-100, preferably 4-60, in particular 5-30, while the capsule type with the gelatine shell has a size of (d50 in [μm]) 80-250, preferably 100-200 and in particular 120-150.

According to the invention, it is preferred that the first type of capsule and the second type of capsule each have an inner phase which comprises polymerizable (meth)acrylate-functional binder, preferably (meth)acrylated epoxy resin and optionally crosslinker, the binder and crosslinker preferably being the same as described above.

For the purposes of the invention, it is particularly advantageous if the inner phases of the first type of capsule and the second type of capsule have the same components, i.e. the capsules then differ essentially only in the type of their shell.

Preferably, the capsules of the first component contain 10 to 88% by weight, particularly preferably 30 to 60% by weight of (meth)acrylate-functional binder, 10 to 88% by weight, preferably 20 to 60% by weight of crosslinker, in particular methacryl-functional crosslinker, and up to 2, particularly 0.2 to 1% by weight of accelerator, in each case as dry weight (solids) based on the dry weight of the capsules of the first component.

More specifically and further preferably, the capsules of the first component may comprise melamine-formaldehyde shell:
12 to 28 wt. %, particularly preferably 15 to 25 wt. %, especially about 20 wt. % shell;
30 to 50% by weight, particularly preferably 35 to 45% by weight, especially about 40% by weight of polymerizable (meth)acrylate-functional binder;
30 to 50% by weight, particularly preferably 35 to 45% by weight, especially about 40% by weight of crosslinker;
0.1 to 1.0% by weight, particularly preferably 0.3 to 0.7% by weight, especially about 0.5% by weight of accelerator, in each case based on the solids content (dry weight) of the capsules.

Also specifically and further preferably, the capsules of the first component may contain gelatin shell:
5 to 20% by weight, particularly preferably 7 to 15% by weight of shell, especially about 10% by weight of shell;
35 to 55% by weight, particularly preferably 40 to 50% by weight, especially about 45% by weight of polymerizable (meth)acrylate-functional binder;
35 to 55 wt. %, particularly preferably 40 to 50 wt. %, especially about 45 wt. % crosslinker;
0.1 to 1.0% by weight, particularly preferably 0.3 to 0.7% by weight of accelerator, especially about 0.5% by weight, in each case based on the solids content (dry weight) of the capsules.

According to the invention, it is preferred that the polymerizable constituents of the first component are essentially radically polymerizable.

Preferred accelerators according to the invention are, for example, amine compounds such as imidazole, 1,3-bis-4-piperidylpropane, 1,6-hexanediamine, methylenedianiline, liquid polyamide of dimerized unsaturated fatty acids (Versamid125), reacted with alkylenediamine, NN′dimethylaniline, NN′diethylaniline, trimethylolamine, triethanolamine, with NN′diethylaniline being particularly preferred.

According to the invention, the second component can particularly preferably contain non-encapsulated water-soluble peroxodisulfate initiator and encapsulated dibenzoyl peroxide initiator. The capsules, in particular microcapsules, of the second component containing the dibenzoyl peroxide initiator preferably have a shell, in particular a gelatine shell, and an inner phase, wherein the inner phase preferably contains the dibenzoyl peroxide initiator dispersed in plasticizer, in particular phthalate-free plasticizer, and wherein the capsules, in particular microcapsules, of the second component containing the dibenzoyl peroxide initiator preferably contain 4 to 35, in particular 6 to 25 wt.-%, particularly preferably 10 to 15 wt.-%, of the dibenzoyl peroxide initiator dispersed in 55 to 90, particularly 60 to 85% by weight, particularly preferably 70 to 80% by weight of plasticizer, particularly phthalate-free plasticizer, in each case dry substance based on the weight of the capsules of the second component. The capsule type containing the peroxide initiator preferably has a size of 130-300, preferably 170-250 and in particular 190-220 (d50 in [μm]).

It is particularly preferred according to the invention that the peroxodisulfate initiator comprises sodium peroxodisulfate initiator, preferably sodium peroxodisulfate initiator.

The multicomponent system according to the invention can preferably contain further constituents, in particular non-reactive resin, wax, pigments, pigment-affine polymers, fillers, wetting agents, biocides, adhesion promoters, defoamers, additives for deaeration and/or rust inhibitors.

Non-reactive resins may for example be selected from common commercially available aqueous binders such as e.g. Wohrleecryl 7123, Roskydal 850W and others, such as those commercially available from resin manufacturers such as Allnex, Alberdingk Boley, DSM Neoresins, BASF and other resin manufacturers known to those skilled in the art.

Waxes which are used, for example, to adjust the coefficient of friction can be selected according to the invention, for example, from commercially available polyethylene water waxes from wax manufacturers such as Byk (Cera), Deurex and others.

Pigments can be used for color marking of certain qualities and are, for example, common organic dyes and/or inorganic pigments. Conventional pigment-affine resins can be used to bind/disperse other components such as pigments. Dispersing additives which are commercially available from additive manufacturers known to the skilled person, such as Byk, EFKA, Tego, for example the products of the Disperbyk series, are advantageous according to the invention.

Fillers suitable for use in the invention include inorganic and organic fillers, in particular, for example, kaolinites, calcites, talc and reactive fillers such as inorganic fillers coated with reactive silane equipped with methacrylic functions. According to the invention, the use of mica is not preferred.

The person skilled in the art is familiar with conventional wetting agents, biocides, adhesion promoters, defoamers, as well as additives for deaeration and/or rust inhibitors, which can be advantageously used in the invention.

The multicomponent system according to the invention preferably contains, in each case in relation to the solids content (“solids”):
25 to 55 parts by weight, preferably 30 to 50 parts by weight, in particular 36 to 44 parts by weight of capsules containing polymerizable (meth)acrylate-functional binder;
0 to 20 parts by weight, preferably 5 to 17 parts by weight, in particular 10 to 14 parts by weight of non-encapsulated reactive binder;
0 to 3.8 parts by weight, preferably 0.5 to 3 parts by weight, in particular 1 to 2.3 parts by weight of non-encapsulated reactive diluent;
1 to 15 parts by weight, preferably 3 to 10 parts by weight, in particular 5 to 8 parts by weight of capsules containing dibenzoyl peroxide initiator;
0.3 to 5 parts by weight, preferably 0.6 to 4 parts by weight, in particular 0.9 to 2 parts by weight, especially preferably 1.1 to 1.5 parts by weight of peroxodisulfate initiator;
1 to 70 parts by weight, preferably 10 to 60 parts by weight, in particular 20 to 50 parts by weight, especially preferably 30 to 40 parts by weight of other ingredients.

This also means that, for example, in the absence of other constituents, the multicomponent system according to the invention contains preferably, in relation to the solids content of the system:
25 to 55% by weight, preferably 30 to 50% by weight, in particular 36 to 44% by weight of capsules containing polymerizable (meth)acrylate-functional binder;
0 to 20% by weight, preferably 5 to 17% by weight, in particular 10 to 14% by weight of non-encapsulated reactive binder;
0 to 3.8% by weight, preferably 0.5 to 3% by weight, in particular 1 to 2.3% by weight of non-encapsulated reactive diluent;
1 to 15% by weight, preferably 3 to 10% by weight, in particular 5 to 8% by weight of capsules containing dibenzoyl peroxide initiator;
0.3 to 5% by weight, preferably 0.6 to 4% by weight, in particular 0.9 to 2% by weight, especially preferably 1.1 to 1.5% by weight of peroxodisulfate initiator;
1 to 70% by weight, preferably 10 to 60% by weight, in particular 20 to 50% by weight, especially preferably 30 to 40% by weight of other constituents.

The multicomponent system according to the invention can, for example, be present as an aqueous slurry or dispersion separated into the components. The ratio of the components to one another is determined by the solids content of the constituents of the components. The multicomponent system according to the invention can be present as a composition, for example in the form of a slurry or dispersion, prepared by mixing the aqueous components of the multicomponent system according to the invention. The proportions of the components (solid components) then are the corresponding proportions of the multicomponent system.

Neither the absolute nor the relative proportions are influenced by the respective amount of water added. The amount of added water is not essential to the invention and can vary over a wide range in order to optimize the shelf life of the components, the mixing of the components and also the application of the mixed composition and the subsequent drying. For example, the amount of added (“free”) water in the first separate component may be 0 to 10 wt % or 2 to 8 wt %, based on the total weight of the first separate component, and/or in the second separate component, 15 wt % to 65 wt % or 20 to 55 wt %, based on the total weight of the second separate component. An advantageous total water content of the mixed composition is, for example, 30 to 50% by weight or 35 to 45% by weight.

The multicomponent system according to the invention can be produced in the following way, for example: Water, non-reactive binder and the additives and dispersing resins are introduced. The fillers are then slowly stirred in and then dispersed. The MF capsules (slurry) are then slowly stirred in, the reactive diluents and the gelatine capsules are added with stirring, and then the pH and viscosity are adjusted. The initiator part can be prepared by adding water, dissolving the sodium peroxodisulphate in it and then adding the BPO capsules while stirring. The two parts (reactive part and initiator part) can be combined by preparing the reactive part (the first component) and adding the initiator part (the second component) while stirring. If necessary, e.g. for special screws, the viscosity can then be adjusted with water. The application can be done manually, but is normally carried out mechanically, e.g. with a disk machine, a linear coating system or a semi-automatic coating system. After application of the aqueous composition according to the invention, the composition is typically dried so that a film having grip remains on the coated screw, for example in the thread area. This film, this coating, ideally has the same dry composition as the aqueous composition before application, based on the solids content.

The multicomponent system or composition according to the invention is preferably used to improve the pot life, the process reliability and/or used for the coating of a fastener, in particular a screw, in order to increase the breakaway torque of the fastener and/or to improve the tightness of the connection of the fastener.

The invention therefore also relates to such a fastener, in particular a screw, which is coated with the composition according to the invention, in particular if it is obtained by applying the multicomponent system according to the invention or the composition according to the invention to the fastener and subsequent drying.

### EXAMPLES

### Example 1

A first component 1.1 was prepared using a slurry of melamine formaldehyde capsules and gelatin capsules, each with an identical inner phase of TMPTA, an amine accelerator and (meth)acrylated epoxy resin. Reactive and non-reactive fillers, thickeners and reactive diluent (polyethylene glycol dimethacrylate) were added to achieve a suitable viscosity.

A second component 1.2 was produced using a main binder and a dispersing resin for the fillers, fillers, process additives for wetting, defoaming, deaeration and against flash rust. The coefficient of friction was adjusted by means of a water wax (0.25 was selected as the typical coefficient of friction), and the coloring components (pigments) were added. The initiator system consisting of sodium persulphate (NAPS) and encapsulated dibenzoyl peroxide was added. The pH value (7-7.5) and the viscosity (25-50 [DIN 6/see]) were adjusted with water and caustic soda.

The multi-component system had the following composition 1 (solids content, % by weight):

TABLE 1

| | | | |
|---|---|---|---|
| Melamine-formaldehyde | 40.57 | Binder ((meth)acrylated epoxy resin) | 16.03 |
| capsules of the first component | | Crosslinker (TMPTMA) | 16.23 |
| | | Accelerator (amine) | 0.19 |
| | | MF shell | 8.11 |
| Gelatine capsules of the first | 2.54 | Binder ((meth)acrylated epoxy resin) | 1.13 |
| component | | Crosslinker (TMPTMA) | 1.14 |
| | | Accelerator (amine) | 0.01 |
| | | Gelatine shell | 0.25 |
| reactive fillers | 1.69 | | |
| Olefin-functional polyurethane | 11.83 | | |
| (non-encapsulated) | | | |
| Reactive thinner polyethylene | 1.69 | | |
| glycol dimethacrylate | | | |
| Reactive diluent | 0.51 | | |
| methacryloylethoxysuccinate | | | |
| Gelatine capsules with dibenzoyl | 6.34 | Plasticizer | 4.62 |
| peroxide | | Dibenzoyl peroxide | 0.82 |
| | | Gelatine shell | 0.91 |
| Sodium peroxodisulfate | 1.27 | | |
| Unreactive polyester resin | 8.45 | | |
| Other additives (biocide, | 25.05 | | |
| dyes/pigments, pigment-affine | | | |
| copolymer, non-reactive fillers, | | | |
| wetting agent, rust inhibitor, | | | |
| wax) | | | |
| NaOH | 0.05 | | |
| Total | 99.99 | | |

### Example 2

A composition according to the invention was applied as a coating to a threaded screw and dried for 24 hours at room temperature. Then the screws were screwed together with nuts and dried for 24 hours at room temperature and the breakaway torque was measured. (Example 2a). As a comparison, an otherwise identical composition was applied to an identical threaded screw, which differed from Example 2a in that the encapsulated dibenzoyl peroxide initiator and the non-encapsulated sodium peroxodisulfate initiator were replaced by non-encapsulated dibenzoyl peroxide initiator in the same molar amount, and dried and screwed under the same conditions (Comparative Example 2b). As a further comparison, Comparative Example 2b was repeated, in which the non-encapsulated dibenzoyl peroxide initiator was replaced by encapsulated dibenzoyl peroxide initiator in the same molar amount (Comparative Example 2c). Finally, as a further comparison, Comparative Example 2a was repeated, in which the non-encapsulated dibenzoyl peroxide initiator was replaced in the same molar amount by non-encapsulated sodium peroxodisulfate initiator (Comparative Example 2d).

There is a surprising synergistic effect of the initiator combination used according to the invention, in that the breakaway torque of the screw coated according to the invention (example 2a) after screwing and curing is considerably higher than in the comparative examples at just under 20 [Nm], almost twice as high as in the case of comparative examples 2b (12 [Nm]) and 2d (10 [Nm]) and still around 25% higher than in comparative example 2c (16 [Nm]).

In a variation of the comparative test, a composition according to the invention containing non-encapsulated sodium persulfate and encapsulated benzoyl peroxide (example 2e) and, for comparison, an otherwise identical composition (comparative example 2f) containing non-encapsulated sodium persulfate and non-encapsulated benzoyl peroxide in the same molar ratio as in example 2e were prepared. Already 2 hours after preparation, a white separation can be observed in comparative example 2f, while example 2e according to the invention remains constantly homogeneous even after 4 days of storage at 40° C.

Compositions 2e and 2f were applied as a coating to one threaded screw each and dried for 24 hours at room temperature. The screws were then screwed together with nuts and dried for 24 hours at room temperature and broken open after 24 hours. The test was repeated after one day and after 4 days of storage of the composition at 40° C. While the breakaway torques using the composition 2e according to the invention remained essentially constant, the screw coated with comparative example 2f could no longer be screwed after 24 hours of storage because the coating had become solid.

### Example 3

A composition according to the invention with encapsulated dibenzoyl peroxide initiator and non-encapsulated sodium dioxopersulfate containing only one type of reactive microcapsules of the first component with melamine-formaldehyde shell was applied as a coating to a threaded screw and dried for 24 hours at room temperature. The screws were then screwed together with nuts and dried for 24 hours at room temperature (example 3a). The same composition was applied to another threaded screw and dried for 24 hours at room temperature. The screws were then screwed together with nuts, dried for 24 hours at room temperature and then treated for 3 hours at 150° C. (example 3b). Examples 3a and 3b were repeated, whereby gelatine capsules of the first component were added to the composition according to the invention and both encapsulated dibenzoyl peroxide initiator and non-encapsulated sodium peroxide initiator were additionally added for stoichiometric equalization (examples 3c and 3d), as well as without addition of gelatin capsules of the first component, but with additional encapsulated dibenzoyl peroxide initiator and non-encapsulated sodium peroxodisulfate initiator (examples 3e and 34.

There is a surprising synergistic effect of the two different capsules of the first component in that the breakaway torque is significantly higher for a comparable stoichiometric amount of polymerizable (meth)acrylate-functional binder when it is present in the form of both capsules with a melamine-formamide shell and capsules with a gelatin shell, whereby this effect is independent of the drying and ageing conditions of the coating. The direct comparison with an analogous increase in the initiator content—without the additional capsule type—only leads to slight increases in the breakaway torque.

TABLE 2
Compositions of the two-component systems (% by weight including water)

| Weight % | Examples 3a/3b | | Examples 3c/3d | | Examples 3e/3f | |
|---|---|---|---|---|---|---|
| Added water | 4.80 | | 4.76 | | 4.76 | |
| Melamine-formaldehyde | 41.00 | | 38.67 | | 41.00 | |
| capsules of the first | | | | | | |
| component (aqueous slurry) | | | | | | |
| Gelatine capsules of the first | — | | 3.87 | | — | |
| component | | | | | | |
| reactive fillers | 5.13 | | 4.87 | | 5.13 | |
| Binder (non-encapsulated) | 20.53 | | 19.33 | | 20.53 | |
| Gelatine capsules with | 2.29 | | 2.50 | | 2.50 | |
| dibenzoyl peroxide | | | | | | |
| Sodium peroxodisulfate | 0.46 | | 0.50 | | 0.50 | |
| Unreactive polyester resin | 5.25 | | 5.21 | | 5.21 | |
| Other additives (biocide, | 17.24 | | 17.1 | | 17.1 | |
| dyes/pigments, pigment-affine | | | | | | |
| copolymer, non-reactive fillers, | | | | | | |
| wetting agent, rust inhibitor, | | | | | | |
| wax); | | | | | | |
| Water | 2.82 | | 2.80 | | 2.80 | |
| NaOH (10%) | 0.47 | | 0.47 | | 0.47 | |
| Total | 99.99 | | 100.08 | | 100 | |
| Breakaway torques [Nm] | 3a | 3b | 3c | 3d | 3e | 3f |
| | | 150° C. | | 150° C. | | 150° C. |
| | 22 | 10 | 25 | 12 | 23 | 10 |

1. Multicomponent system comprising a first component, a second component and optionally one or more further components,
wherein the first component comprises capsules containing polymerizable (meth)acrylate functional binder and water, and
wherein the second component comprises peroxodisulfate initiator, encapsulated dibenzoyl peroxide initiator and water.

2. (canceled)

3. A multicomponent system according to claim 1, characterized in that the first component comprises capsules, wherein the capsules have a shell and an inner phase, wherein the inner phase comprises polymerizable (meth)acrylate-functional binder and optionally crosslinker, optionally comprising one or more accelerators and wherein the polymerizable (meth)acrylate-functional binder is selected from the group consisting of (meth)acrylated epoxy resin, (meth)acrylated polyurethane, bisphenol-A-based (meth)acrylate-functional binder, novolak-based (meth)acrylate-functional binder and mixtures thereof.

4. A multicomponent system according to claim 1, characterized in that the crosslinker is prefer-ably-selected from (meth)acrylic functional monomers selected from the group consisting of trimethylpropane tri(meth)acrylate, 1,3-butanediol dimethacrylate (BGDMA); tripropylene glycol diacrylate (TRPGDA); trimethylolpropane trimethacrylate (TMPTMA), isocyanurate tri(meth)acrylate, PETA pentaerythritol tetra(meth)acrylate, DiPETA di-pentaerythritol tetra(meth)acrylate, dipentaerythritol pentaacrylate.

5. Multicomponent system according to claim 4, characterized in that the first component additionally contains one or more non-encapsulated polymerizable component(s).

6. Multicomponent system according to claim 5, characterized in that the first component comprises at least two different types of capsules which differ at least in the material of their respective shells.

7. Multicomponent system according to claim 6, characterized in that the first type of capsule and the second type of capsule each have an inner phase comprising polymerizable (meth)acrylate-functional binder.

8. Multicomponent system according to claim 6, characterized in that the inner phases of the first type of capsule and of the second type of capsule have the same constituents, in that the capsules of the first component contain 10 to 88% by weight by of (meth)acrylate-functional binder, 10 to 88% by weight by weight, of crosslinker, and up to 2% by weight of accelerator, in each case as dry weight based on the solids content of the capsules of the first component.

9. Multicomponent system according to claim 6, characterized in that
a) the capsules of the first component with melamine-formaldehyde shell contain:
12 to 28 wt. % shell;
30 to 50% by weight of polymerizable (meth)acrylate-functional binder;
30 to 50% by weight of crosslinker;
0.1 to 1.0% by weight of accelerator based on the solids content of the capsules;
and/or
b) the capsules of the first component with a gelatine shell contain:
5 to 20% by weight of shell;
35 to 55% by weight of polymerizable (meth)acrylate-functional binder;
35 to 55 wt. % crosslinker;
0.1 to 1.0% by weight based on the solids content of the capsules.

10. Multicomponent system according to claim 1, characterized in that the polymerizable constituents of the first component are essentially radically polymerizable.

11. Multicomponent system according to claim 1, characterized in that the second component contains non-encapsulated water-soluble peroxodisulfate initiator and encapsulated dibenzoyl peroxide initiator, the capsules of the second component containing the dibenzoyl peroxide initiator having a shell, and an inner phase, the inner phase containing the dibenzoyl peroxide initiator dispersed in plasticizer and wherein the capsules of the second component containing the dibenzoyl peroxide initiator preferably contain 4 to 35% by weight of dibenzoyl peroxide initiator dispersed in 55 to 90 based on the weight of the capsules of the second component.

12. Multicomponent system according to claim 1, characterized in that the peroxodisulfate initiator comprises sodium peroxodisulfate initiator.

13. Multicomponent system according to claim 12, further comprising non-reactive resin, wax, pigments, pigment-affine polymers, fillers, wetting agents, biocides, adhesion promoters, defoamers, additives for deaeration and/or rust inhibitors.

14. Multicomponent system according to claim 1, characterized in that the system contains, in each case based on the solids content:
25 to 55 parts by weight of capsules containing polymerizable (meth)acrylate-functional binder;
0 to 20 parts by weight of non-encapsulated reactive binder;
0 to 3.8 parts by weight of non-encapsulated reactive diluent;
1 to 15 parts by weight of capsules containing dibenzoyl peroxide initiator;
0.3 to 5 parts by weight of peroxodisulfate initiator;
1 to 70 parts by weight of other ingredients.

15. Use of the multicomponent system according to claim 1 as a sealant and/or adhesive for coating fasteners.

16. Use of the multicomponent system according to claim 1 for improving the pot life, the process reliability and/or for coating a fastener in order to increase the breakaway torque of the fastener and/or to improve the tightness of the joint of the fastener.

17. Fastener characterized in that it is coated with the composition according to claim 15.

18. Fastener according to claim 17, obtainable by applying the multicomponent system according to claim 1 to the fastener and subsequent drying.
